(19) United States
(12) Patent Application Publication
(10) Pub. No.: US 2016/0357886 A1
(43) Pub. Date: Dec. 8, 2016

(54) SYSTEM FOR ANALYTIC MODEL DEVELOPMENT

(71) Applicant: Intel Corporation, Santa Clara, CA (US)

(72) Inventors: CELESTE FRALICK, Chandler, AZ (US); RITA CHATTOPADHYAY, Chandler, AZ (US); SEBASTIAN SCHOENBERG, Hillsboro, OR (US); DONALD SCOTT WILDE, Chandler, AZ (US); PHILLIP GURBACKI, Scottsdale, AZ (US)

(73) Assignee: Intel Corporation, Santa Clara, CA (US)

(21) Appl. No.: 14/731,279

(22) Filed: Jun. 4, 2015

(51) Int. Cl. G06F 17/50; G06F 3/0482; G06F 9/44; G06F 3/0484

(52) U.S. Cl. CPC G06F 17/5009; G06F 3/04842; G06F 3/04847; G06F 3/0482; G06F 9/4446

(57) ABSTRACT

This disclosure is directed to a system for analytic model development. In general, an analytic system may be able to formulate a model of a target system based on user interaction and data received from the system, and to perform real time activities based on the model. An analytics system may comprise at least a segment recipe module (SRM), a user interface module (UIM) and an automated analytics module (AAM). The SRM may include at least one segment recipe for use in configuring the UIM and AAM. For example, the UIM may be configured to present plain language prompts to a user. At least one of the segment recipe or data input by the user in response to the prompts may be used to configure the AAM to generate the model. The AAM may also perform real time activities that generate notifications, etc. based on the model.

### TECHNICAL FIELD

The present disclosure relates to system modeling and analysis, and more particularly, to an automated analytic system that is equipped to facilitate interaction with lower skill level users.

### BACKGROUND

Data analytics is, in general, the science of analyzing data for the purpose of formulating some sort of conclusion about the data (e.g., characteristics of the data), a system that generated the data (e.g., a “target” system), etc. For example, data collected from a target system may be utilized to generate a model that may be able to predict what the output of the target system will be given a certain input. The model of the target system may then be employed for a variety of uses. For example, the model may predict how variations in the target system (e.g., determined based on sensed changes in input data) will affect the output of the target system, which may be used to generate a notification when the output of the target system is determined to be moving outside of a specified performance window and to determine corrective action to bring the target system back within the specified performance window, etc. A correctly configured model may be capable of very accurately predicting target system performance, which may help to prevent the expenditure of substantial resources on solutions that may have nothing to do with the actual problem. For example, the model may elucidate the effects of proposed solutions to a problem in the target system, and thus, may help avoid implementing solutions that will not fix the problem.

While the benefits that may be realized through data analytics are readily apparent, what is required to generate a model that accurately predicts reaction to systemic changes may not be quite as clear. An expert in the field of data analytics (e.g., a data scientist) is typically required to frame a problem, collect data, determine “features” (e.g., factors that may contribute to system performance), formulate a model, verify the accuracy of the model and interpret the output of the model (e.g., to propose corrective action). While automated (e.g., computer-based) data analytic systems currently exist, data scientist participation is still required to configure these systems in that a system user must be familiar with how to frame the problem, data analytics terminology, methodology, data processing algorithms, how to interpret model outputs, etc. The continuing requirement for a data scientist to comprehend the situation, determine modeling methodology and interpret the results necessitates the inclusion of a human expert in existing automated data analytics solutions, which may impede system performance, wide-spread system adoption, etc.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system for analytic model development in accordance with at least one embodiment of the present disclosure;

FIG. 2 illustrates an example configuration for at least one device usable in accordance with at least one embodiment of the present disclosure;

FIG. 3 illustrates an example configuration for a segment recipe module in accordance with at least one embodiment of the present disclosure;

FIG. 4 illustrates an example configuration for an automated analytics module in accordance with at least one embodiment of the present disclosure;

FIG. 5 illustrates example operations for analytic model development in accordance with at least one embodiment of the present disclosure;

FIG. 6 illustrates example operations for analytics system configuration and data processing in accordance with at least one embodiment of the present disclosure;

FIG. 7 illustrates example operations for feature generation and selection in accordance with at least one embodiment of the present disclosure; and

FIG. 8 illustrates example operations for model generation and validation, and real time operation in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to a system for analytic model development. In general, an analytic system may be able to formulate a model of a target system based on user interaction and data received from the system, and to perform real time activities based on the model. An analytics system may comprise at least a segment recipe module (SRM), a user interface module (UIM) and an automated analytics module (AAM). The SRM may include at least one segment recipe corresponding to, for example, a particular usage, application, industry, etc. A manual or automated selection operation may cause a segment recipe to be selected for configuring at least the UIM and AAM. For example, the segment recipe may include data for configuring the UIM to present plain language prompts to a user. Input provided by the user may then be employed in configuring the AAM. The AAM may include at least a data preprocessing engine, a feature generation engine, a feature selection engine, and a model development engine. At least one of the segment recipe and the user input may be used to configure the engines, which may utilize data received from the target system to generate a model. After model generation, a real time engine in the AAM may receive data from the target system and may generate notifications, control signals, etc. based on the model output.

In at least one embodiment, an analytics system may comprise, for example, a processing module, a UIM, an AAM and a SRM. The UIM may be to allow a user to interact with the analytics system. The AAM may be to cause the processing module to at least generate a model of a target system. The SRM may be to cause the processing module to configure the user interface module and the automated analytics module.

The SRM may comprise at least one segment recipe and a segment recipe selection module. In at least one example implementation, the SRM may comprise a plurality of segment recipes and the segment recipe selection module may be to select a segment recipe to configure the UIM and the AAM based on user interaction with the UIM. In the same or a different implementation, the SRM may comprise a plurality of segment recipes and the segment recipe selection module may be to select a segment recipe to configure the UIM and the AIM based on data received from the target system. The segment recipe module may further comprise, for example, a segment recipe adaptation module to alter at least part of the at least one segment recipe based on data received from sources internal or external to the analytics system. The at least one segment recipe may comprise a user interaction/terminology configuration to at least cause the UIM to present prompts configured to guide the user in inputting data for use in configuring the AAM. For example, the prompts may be formulated using plain language. The at least one segment recipe may further comprise at least a general configuration, a data configuration and a model configuration.

In at least one embodiment, the AAM may comprise at least a data preprocessing engine, a feature generation engine, a feature selection engine and a model development and validation engine. An example model development and validation engine may be to generate a plurality of models based at least on data received from the target system and to determine a best model from the plurality of models based on measuring a goodness of fit for teach of the plurality of models. An example feature selection engine may be to generate a training feature matrix for training the plurality of models.

In at least one embodiment, the AAM may further comprise a real time engine to input data received from the target system into the model and cause at least one of a notification to be presented by the user interface module, or a control signal to be transmitted to the target system, based on an output generated by the model. In providing a notification, the real time engine may be to cause the user interface module to present at least one of a prediction, a diagnosis or an alarm. Consistent with the present disclosure, an example method for model development may comprise configuring an analytics system based at least on a segment recipe, preprocessing, in the analytics system, data received from a target system, generating, in the analytics system, features based on the preprocessed data, selecting, in the analytics system, a set of features from the generated features and generating, in the analytics system, a model based on the selected set of features.

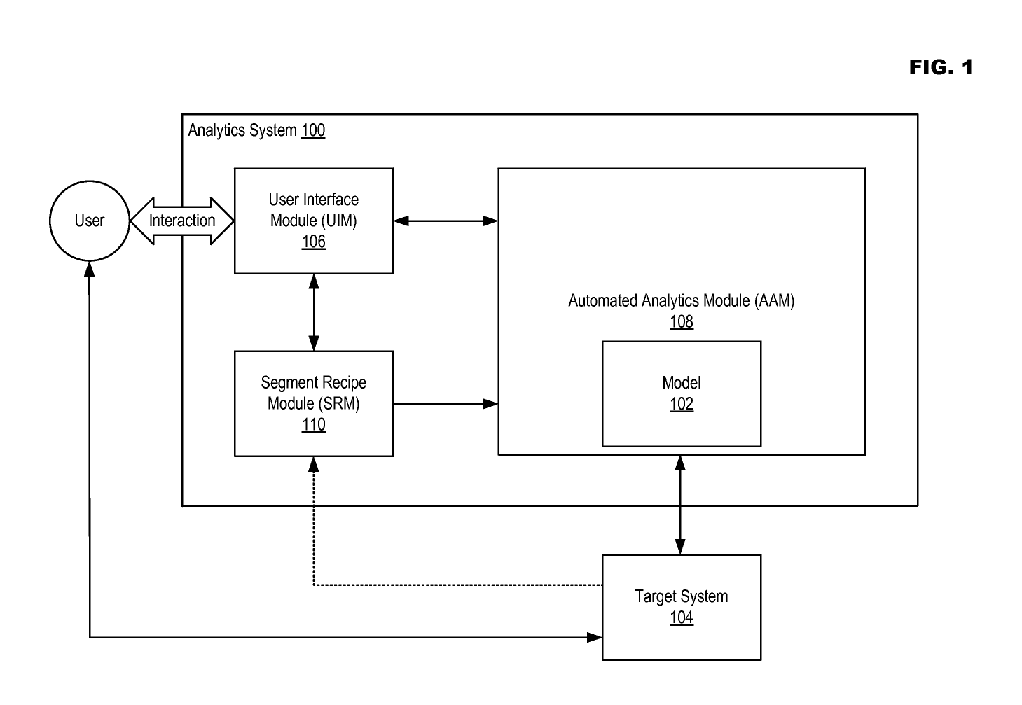

FIG. 1 illustrates an example system for analytic model development in accordance with at least one embodiment of the present disclosure. Analytics system 100 may be implemented on a single device or on a combination of similarly configured devices (e.g., a group of rack or edge servers) or differently configured devices (e.g., a wearable interface device and a data processing device). Examples of various devices with which analytics system 100 may be implemented may include, but are not limited to, a mobile communication device such as a cellular handset or a smartphone based on the Android® OS from the Google Corporation, iOS® or Mac OS® from the Apple Corporation, Windows® OS from the Microsoft Corporation, Linux® OS, Tizen® OS and/or other similar operating systems that may be deemed derivatives of Linux® OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., a mobile computing device such as a tablet computer like an iPad® from the Apple Corporation, Surface® from the Microsoft Corporation, Galaxy Tab® from the Samsung Corporation, Kindle® from the Amazon Corporation, etc., an Ultrabook® including a low-power chipset from the Intel Corporation, a netbook, a notebook, a laptop, a palmtop, etc., a wearable device such as a wristwatch form factor computing device like the Galaxy Gear® from Samsung, an eyewear form factor computing device/user interface like Google Glass® from the Google Corporation, a virtual reality (VR) headset device like the Gear VR® from the Samsung Corporation, the Oculus Rift® from the Oculus VR Corporation, etc., a typically stationary computing device such as a desktop computer, a server, a group of computing devices organized in a high performance computing (HPC) architecture, a smart television or other type of “smart” device, small form factor computing solutions (e.g., for space-limited applications, TV set-top boxes, etc.) like the Next Unit of Computing (NUC) platform from the Intel Corporation, etc.

In general, analytics system 100 may be able to receive input from a user, and to generate an analytic model (hereafter, “model 102”) of target system 104 based at least on the user input. For example, target system 104 may be a manufacturing process, the user may be an operator of the manufacturing process, the user input may be information about the manufacturing process including, for example, process type, available inputs, desired outputs, etc. Model 102 generated by analytic system 100 may be able to at least predict outputs of the manufacturing process based on certain values of the inputs. More functional embodiments may employ the prediction ability of the model to warn the user of process variation, propose corrective action, control the process itself, etc. Configuring analytics system 100 would typically require a high level of skill, such as that possessed by a data scientist. However, embodiments consistent with the present disclosure make the ability to both configure and use data analytics available to a much larger pool of users.

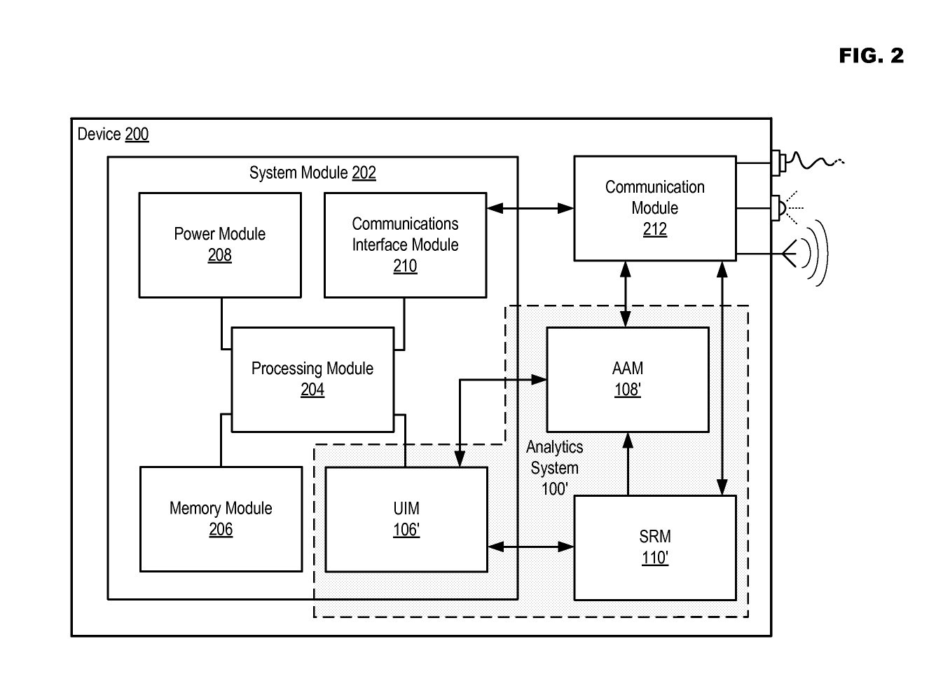

Analytics system 100 may comprise, for example, UIM 106, AAM 108 and SRM 110. UIM 106 may comprise software and/or equipment configured to support user interaction with analytics system 100. In at least one embodiment, UIM 106 may be configured to prompt the user in regard to configuring analytics system 100. As referenced herein, “prompts” may include presenting text, audio, images, video and/or tactile input to the user to elicit a response (e.g., user input) from the user. Equipment that may make up UIM 106 will be discussed further in regard to FIG. 2. AAM 108 may be configured to generate model 102 of target system 104. Model 102 may be generated by request of the user and/or may be regenerated by AAM 108 whenever, for example, predictions generated by model 102 are determined to not be within a required degree of accuracy with respect to how target system 104 may actually perform, whenever a change is determined to have occurred in target system 104, etc. In at least one embodiment, AAM 108 may also support real time functionality. As referenced herein, “real time” functionality may include activities that are provided by AAM 108 based on model 102 when target system 104 is operational such as, but not limited to, notification services related to predicted output deviation, problem diagnosis, proposed corrective actions based on predicted effect, process control, etc.

In at least one embodiment, SRM 110 may configure UIM 106 and/or AAM 108 based on a particular segment with which target system 104 may be associated. As referenced herein, “segment” may be pertain to a particular usage, application, industry, etc. in which target system 104 may be categorized. For example, given the broad category of maintenance, a segment may be aeronautical maintenance. Taking aircraft maintenance as an example, SRM 110 may be able to configure UIM to present prompts that pertain to aircraft maintenance and that utilize aircraft maintenance terminology. Moreover, the prompts may be presented using plain language. As referenced herein, “plain language” may be language that a typical user of analytical system 100 may comprehend without having to perform inquiry or research. For example, given the aircraft maintenance example, UIM 106 may prompt the user by asking questions such as “what do you want to do,” “what is the type of aircraft,” “is there a problem with the aircraft,” “what part of the aircraft is experiencing a problem,” etc. In this manner, a user having segment knowledge (e.g., knowledge of target system 104, the operation and terminology of target system 104, etc.) may be able to configure analytics system 100 without a requisite knowledge of data analytics.

FIG. 2 illustrates an example configuration for at least one device usable in accordance with at least one embodiment of the present disclosure. The inclusion of an apostrophe after an item number (e.g., 100′) in the present disclosure may indicate that an example embodiment of the particular item is being illustrated. For example, device 200 may be capable of supporting any or all of the activities associated with analytics system 100′ in FIG. 1. However, device 200 is presented herein only as an example of an apparatus usable in embodiments consistent with the present disclosure, and is not intended to limit any of the various embodiments disclosed herein to any particular manner of implementation. Moreover, while only one device 200 that may include various modules is shown in FIG. 2, this arrangement is merely an example. The functionality associated with the modules may also be allocated amongst a plurality of devices.

Device 200 may comprise, for example, system module 202 to manage operation of the device. System module 202 may include, for example, processing module 204, UIM 106′, memory module 206, power module 208 and communications interface module 210. Device 200 may further include communication module 212, AAM 108′ and SRM 110′. While communication module 212, AAM 108′ and SRM 110′ are illustrated as separate from system module 202, the example configuration shown in FIG. 2 has been provided merely for the sake of explanation. Some or all of the functionality associated with communication module 212, AAM 108′ and SRM 110′ may also be incorporated into system module 202.

In device 200, processing module 204 may comprise one or more processors situated in separate components, or alternatively one or more processing cores situated in one component (e.g., in a system-on-chip (SoC) configuration), along with processor-related support circuitry (e.g., bridging interfaces, etc.). Example processors may include, but are not limited to, various x86-based microprocessors available from the Intel Corporation including those in the Pentium, Xeon, Itanium, Celeron, Atom, Quark, Core i-series, Core M-series product families, Advanced RISC (e.g., Reduced Instruction Set Computing) Machine or “ARM” processors or any other evolution of computing paradigm or physical implementation of such integrated circuits (ICs), etc. Examples of support circuitry may include chipsets (e.g., Northbridge, Southbridge, etc. available from the Intel Corporation) configured to provide an interface through which processing module 204 may interact with other system components that may be operating at different speeds, on different buses, etc. in device 200. Moreover, some or all of the functionality commonly associated with the support circuitry may also be included in the same physical package as the processor (e.g., such as in the Sandy Bridge family of processors available from the Intel Corporation).

Processing module 204 may be configured to execute various instructions in device 200. Instructions may include program code configured to cause processing module 204 to perform activities related to reading data, writing data, processing data, formulating data, converting data, transforming data, etc. Information (e.g., instructions, data, etc.) may be stored in memory module 206. Memory module 206 may comprise random access memory (RAM) and/or read-only memory (ROM) in a fixed or removable format. RAM may include volatile memory configured to hold information during the operation of device 200 such as, for example, static RAM (SRAM) or Dynamic RAM (DRAM). ROM may include non-volatile (NV) memory modules configured based on BIOS, UEFI, etc. to provide instructions when device 200 is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power module 208 may include internal power sources (e.g., a battery, fuel cell, etc.) and/or external power sources (e.g., electromechanical or solar generator, power grid, external fuel cell, etc.), and related circuitry configured to supply device 200 with the power needed to operate. UIM 106′ may include hardware and/or software to allow users to interact with device 200 such as, for example, various input mechanisms (e.g., microphones, switches, buttons, knobs, keyboards, speakers, touch-sensitive surfaces, one or more sensors configured to capture images and/or sense proximity, distance, motion, gestures, orientation, biometric data, etc.) and various output mechanisms (e.g., speakers, displays, lighted/flashing indicators, electromechanical components for vibration, motion, etc.). The hardware in UIM 106′ may be incorporated within device 200 and/or may be coupled to device 200 via a wired or wireless communication medium. In an example implementation wherein device 200 is made up of multiple devices, UIM 106′ may be optional in devices such as, for example, servers (e.g., rack server, blade server, etc.) that omit UIM 106′ and instead rely on another device (e.g., an operator terminal) for user interface functionality.

Communications interface module 210 may be configured to manage packet routing and other control functions for communication module 212, which may include resources configured to support wired and/or wireless communications. In some instances, device 200 may comprise more than one communication module 212 (e.g., including separate physical interface modules for wired protocols and/or wireless radios) managed by communications interface module 210. Wired communications may include serial and parallel wired or optical mediums such as, for example, Ethernet, USB, Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the RF Identification (RFID) or Near Field Communications (NFC) standards, infrared (IR), etc.), short-range wireless mediums (e.g., Bluetooth, WLAN, Wi-Fi, ZigBee, etc.), long range wireless mediums (e.g., cellular wide-area radio communication technology, satellite-based communications, etc.), electronic communications via sound waves, lasers, etc. In one embodiment, communications interface module 210 may be configured to prevent wireless communications that are active in communication module 212 from interfering with each other. In performing this function, communications interface module 210 may schedule activities for communication module 212 based on, for example, the relative priority of messages awaiting transmission. While the embodiment disclosed in FIG. 2 illustrates communications interface module 210 being separate from communication module 212, it may also be possible for the functionality of communications interface module 210 and communication module 212 to be incorporated into the same module.

Consistent with the present disclosure, analytics system 100′ may comprise at least UIM 106′, AAM 108′ and SRM 110′ in device 200. In an example of operation, UIM 106′ may interact with at least AAM 108′ and SRM 110′. In addition to serving as a general user interface for at least device 200 (e.g., which may be performed through interaction with at least processing module 204), a user interacting with UIM 106′ may generate input data for use in configuring at least one of AAM 108′ and SRM 110′. AAM 108′ may receive configuration data from one or both of UIM 106′ and SRM 110′, may receive data from target system 104 via communication module 212 and may provide model-related output data (e.g., data that may be utilized for real time functionality such as notifications) to UIM 106′. SRM 110′ may receive selection data from UIM 106′ and may provide configuration data to UIM 106′ and AAM 108′. In at least one embodiment, SRM 110′ may also interact with communication module 212 to load updates, etc. Consistent with the present disclosure, some or all of UIM 106′, AAM 108′ and SRM 110′ may be implemented at least partially as software that may be, for example, stored in whole or in part in memory module 206 and executed by processing module 204 in device 200.

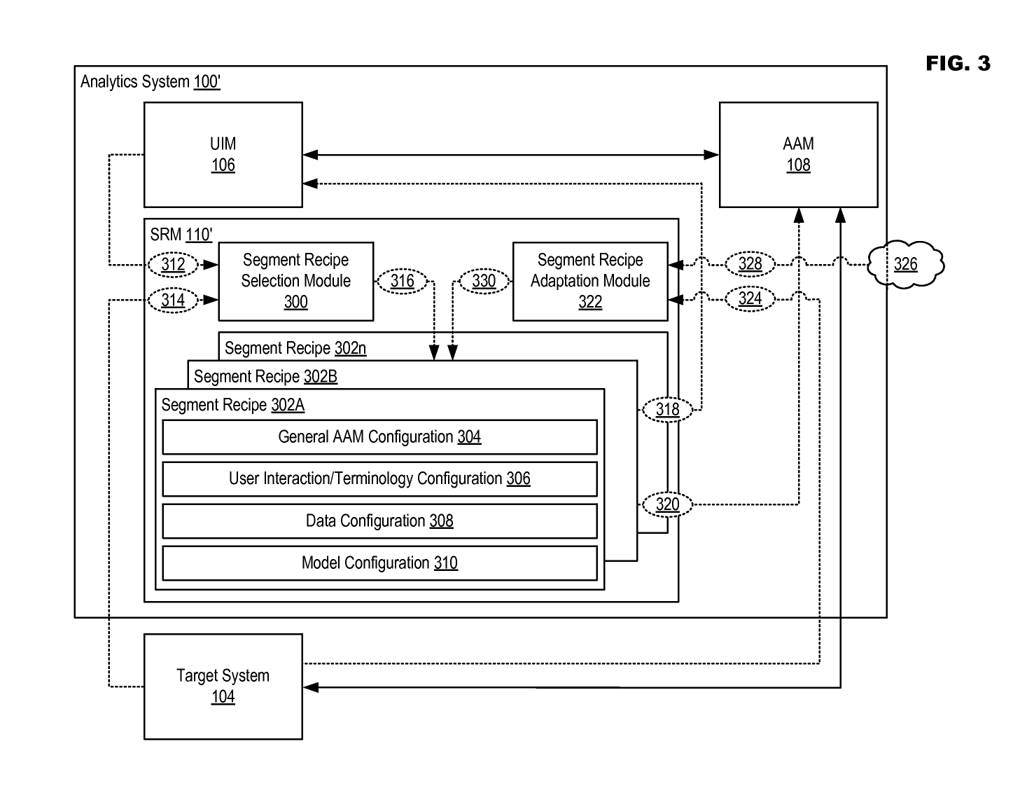

FIG. 3 illustrates an example configuration for an SRM in accordance with at least one embodiment of the present disclosure. SRM 110′ is illustrated within the context of analytics system 100′. SRM 100′ may comprise at least segment recipe selection module 300 and segment recipe 302A, segment recipe 302B . . . segment recipe 302n (collectively, “segment recipes 302A . . . n”). While three segment recipes 302A . . . n are illustrated in FIG. 3, SRM 110′ may comprise fewer or more of segment recipes 302A . . . n. Segment recipe selection module 300 may be configured to cause at least one segment recipe 302A . . . n to be loaded into analytics system 100′. For example, segment recipe selection module 300 may receive input from UIM 106 as shown at 312, or target system 104 as shown at 314, and may use this input to determine which segment recipes 302A . . . n to load as shown at 316. In at least one embodiment, a user of analytics system 100′ may interact with UIM 106 to select a segment recipe 302A . . . n to be loaded into analytics system 100′ (e.g., by entering the name of a segment recipe 302A . . . n to load into a load dialog, by selecting from a list of segment recipes 302A . . . n, by providing a segment recipe 302A . . . n from portable storage media, downloading from the Internet, etc.). Alternatively, target system 104 may provide data to segment recipe selection module 300 that may allow an appropriate segment recipe 302A . . . n to be loaded. Examples of data that may be provided by target system 104 may include, but are not limited to, segment identification data, target system identification data, identification data that corresponds to at least one device in target system 104, data sensed from within target system 104 such as, but not limited to, logged time-series data, performance and success metrics, etc. Segment recipe selection module 300 may utilize the user or system data to cause a segment recipe 302A . . . n to be loaded.

Each segment recipe 302A . . . n may comprise at least one configuration that, upon loading a segment recipe 302A . . . n, may configure at least one of UIM 106 or AAM 108. In at least one embodiment, segment recipes 302A . . . n may each include general AAM configuration 304, user interaction/terminology configuration 306, data configuration 308 and model configuration 310. General AAM configuration may comprise, for example, programmatic architecture information (e.g., directory names, raw data file names, save file names, etc.) and other information that may be utilized to configure the operation of AAM 108 and/or analytic system 100′ in general. User interaction/terminology configuration 306 may information for configuring UIM 106. In at least one embodiment, UIM 106 may be configured to allow a user having at least a modicum of skill with respect to the particular segment (e.g., given that the segment is electronics manufacturing, the user may at least be a technician with familiar with the particular electronics manufacturing process) and with little or no required skill in regard to data analytics. To achieve this goal, user interaction/terminology configuration 306 may include, for example, segment-specific prompts composed using segment-specific terminology that will lead a user to formulate configurations for analytics system 100′, and more specifically AAM 108, that may be typically associated with desired data analytics for the segment. For example, the prompts may comprise questions having answers that may be presented in a selectable manner (e.g., drop down, radio button, check box or another typical soft interface). The questions may begin generally (e.g., what do you want to do?) and may get more specific (e.g., do you want to analyze placement deviation for a particular surface mount placement machine?). Once a data analytics objective is established, the prompts may further elicit configuration specific information such as what input data is available for use in formulating a model, what is the desired output (e.g., real time monitoring functionality), etc. In at least one embodiment, the prompts may be presented in plain language. This allows a user not familiar with data analytics to configure analytics system 100 without undue research and/or frustration. The plain language may, however, be enhanced with segment-specific terminology that may leverage the knowledge of the user when establishing how best to configure model 102.

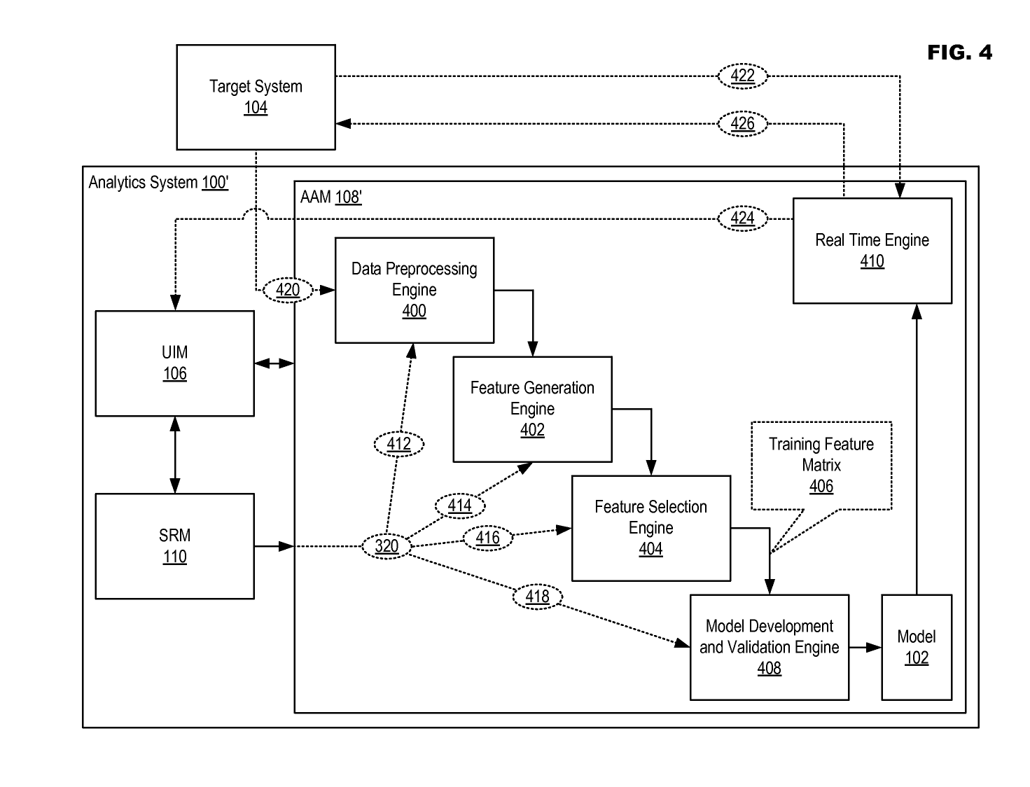

Data configuration 308 and model configuration 310 may comprise settings for use in data analytics performed by AAM 108. Data configuration 308 may inform AAM 108 of data that may be used in generating model 102, characteristics of this data, etc. Data configuration 308 may include, for example, at least one of available data types, typical sampling rates for the available data, noise and outlier information, variable names, etc. Model configuration 310 may provide scope and parameters for formulating model 102. Model configuration 310 may include, for example, at least one of model objective, necessary features for extraction, feature extraction methods, frequency bands, physics-based models, model fit methods, minimum/maximum model accuracy requirements, validation parameters, etc. As shown at 318 and 320, configurations 304 to 310 may be provided to at least UIM 106 and AAM 108 to configure analytics system 100′ based on the particular segment. For example, UIM 106 may utilize user interaction/terminology configuration 306 to configure prompts for interacting with a system user. In a similar manner, AAM 108 may utilize general AAM configuration 304, data configuration 308 and/or model configuration 310 to configure model generation. Examples of AAM 108 and how model 102 may be generated by analytics system 100′ will be explained with respect to FIG. 4-8.

In at least one embodiment, SRM 110′ may further comprise segment recipe adaptation module 322. In general, segment recipe adaptation module 322 may receive feedback data from target system 104, as shown at 324, and other sources 326, as shown at 328, and may utilize the feedback data to modify segment recipes 302A . . . n as shown at 330. Segment recipe adaptation module 322 may modify, or may cause SRM 110′ and/or AAM 108 to modify, general AAM configuration 304, user interaction/terminology configuration 306, data configuration 308 and/or model configuration 310 to selectively improve the adaptation and appropriateness of segment recipes 302A . . . n, which may in turn improve the performance and effectiveness of analytics system 100′. The receipt of feedback data 324 and 328, and/or the modification of segment recipes 302A . . . n, may occur periodically, based on the availability of feedback data 324 and/or 328, upon determination that model 102 is not predicting the behavior of target system 104 with the requisite or desired accuracy, etc. Feedback data 324 from target system 104 may comprise, for example, data about changes to the makeup and/or arrangement of target system 104, data about process changes in target system 104, data about changes in the input to, and/or output from, target system 104, etc. Other sources of data 326 may include sources inside and outside of analytics system 100′. For example, other modules in analytics system 100′ like UIM 106, AAM 108, etc. may provide feedback data 328 to help refine, improve, optimize, etc. segment recipes 302A . . . n. In this regard, feedback data 328 may comprise “domain-specific crowd-sourced response analytics.” Domain-specific crowd-sourced response analytics may include, for example, data determined based on user interaction with UIM 106 such as, but not limited to, user indecision measured during interaction with analytics system 100′ that may be determined by, for example, analyzing user response times to segment recipe-configured prompts, changes in a user's input prior to the user committing the input, the number of attempts made by the user to obtain assistance during the interaction, the category/type of assistance requested by the user, etc. Domain-specific crowd-sourced response analytics may also comprise data received from sources external to analytics system 100′ including, for example, performance feedback from other entities that may interact with target system 104 (e.g., quality evaluators, downstream processors of an output of target system 104, end consumers, etc.), artificial intelligence-driven data collection and/or data analysis performed by web-based entities (e.g., “Siri” developed by the Apple Corporation, “Cortana” developed by the Microsoft Corporation, etc.), etc.

FIG. 4 illustrates an example configuration for an AAM in accordance with at least one embodiment of the present disclosure. AAM 108′ may comprise at least one “engine” for data processing. An engine may include data processing equipment that may be programmed with firmware-based code, software-based applications, etc. In at least one embodiment, processing module 204 may provide at least a portion of the data processing power required by the engines utilizing, for example, at least one central processor unit (CPU) alone or assisted by a variety of coprocessors.

AAM 108′ may comprise, for example, at least data preprocessing engine 400, feature generation engine 402, feature selection engine 404 and model development and validation engine 408. In an example of operation, initially one or more of engines 400 to 408 may be configured by data provided by UIM 106 and/or SRM 110. A user may interact with UIM 106 to cause SRM 110 to load one of segment recipes 302A . . . n. In addition to configuring UIM 106 as discussed in regard to FIG. 3, segment recipes 302A . . . n may also configure AAM 108′ as shown at 320. In particular, data preprocessing engine may be configured as shown at 412 (e.g., based on data configuration 308), feature generation engine 402 may be configured as shown at 414, feature extraction engine may be configured as shown at 416 and model development and validation engine 408 may be configured as shown at 418 (e.g., based on at least one of general AAM configuration 304, data configuration 308 or model configuration 310). A user may then interact with UIM 106 (e.g., based on user interaction/terminology configuration 306) to generate input data (e.g., including model objective, available inputs, desired functionality, etc.) that may be employed to further refine the configuration of AAM 108′. At this point AAM 108′ may be ready to develop model 102 (e.g. or to redevelop or retrain model 102 in an instance where it is determined that target system 104 has changed, model 102 is not providing a requisite level of accuracy, etc.). Actual use of model 102 will be explained below regarding real time engine 410.

Data preprocessing engine 400 may receive raw data as illustrated at 420 and preprocess the raw data for use by feature generation engine 402. In at least one embodiment, the raw data may be annotated data. Annotated data is data generated by target system 104 that is further associated with a condition of target system 104. For example, data sensed by at least one sensor may be associated with target system 104 running normally, requiring recalibration, requiring service, etc. These associations may be made by an operator of target system 104, automatically by a system that may record various sensor readings during state changes of target system 104, etc. Data preprocessing engine 400 may perform operations such as, but not limited to, synchronizing data received from different sources (e.g., various sensors in target system 104), filtering data for noise, determining data distribution, identifying outliers, etc. Determining data distribution may involve testing for normality in data. Examples of data normality tests may include, but are not limited to, the Kolmogorov-Smirnov (KS) test, the Shapiro-Wilk test, the Pearson distribution test, etc. Outliers may be determined by employing various statistical measures including, but not limited to, determining threshold, mean+N*standard deviation, median, Grubbs testing, etc. The preprocessed data may be provided to feature generation engine 402, which may proceed to generate features based on the preprocessed data. Features may be generated by performing various mathematical and statistical operations on the raw data within the time and frequency domain. Example time domain features may include, but are not limited to, mean, standard deviation, “skewness” (e.g., Kurtosis average), root mean square (RMS), number of zero crossings, raw number of maximum peaks, average distance between peaks, etc. Mean, standard deviation, skewness and RMS may be determined statistically. A number of zero crossings may be determined by counting the number of times that data received from target system 104 (e.g., at least one sensor signal) crosses the mean value in a certain window of time. A peak value may be determined by the maximum value that sensor signal obtained in every window. Example frequency domain features may include, but are not limited to, median frequency, mean frequency, spectral energy, spectral entropy, mean of linear envelope, peak of linear envelope, variance of linear envelope and rise time of linear envelope, etc. The resulting features may describe characteristics of the raw data. Some of the features may be non-determinative (e.g., may not be an actual number, may be infinite, etc.), and these features may be removed. The resulting features may be provided to feature selection engine 404. Feature selection engine 404 may perform feature extraction based on a variety of methodologies. The goal of feature extraction is to select a subset of the full group of available features that is most determinative or discriminative of the operation of target system 104. For example, some features in the group of available features may not be determinative at least with respect to the objective of model 102 (e.g., to track an output characteristic of target system 104, to monitor a maintenance issue in target system 104, etc.). These features may be eliminated by feature selection engine 404. In at least one embodiment, feature selection engine 404 may be able to determine the “goodness of fit” of the selected features extracted using different methods. Example feature extraction methods may include, but are not limited to, the RELIEF algorithm, the RELIEFF algorithm, the sequential search algorithm, the Information Gain (InfoGain) algorithm, the Chi-squared algorithm, etc. Goodness of fit may determine how closely the selected features predict the output of target system 104 based on the proposed objective of model 102 (e.g., whether the purpose of model 102 is to be descriptive, diagnostic, predictive or prescriptive). The resulting selected features may be utilized to generate training feature matrix 410 for use in training models developed by model development and validation engine 408.

The feature subset determined by feature selection engine 404 may then be provided to model development and validation engine 408. Model development and validation engine 408 may use the selective features to formulate model 102. In at least one embodiment, one or more modeling methodologies may be employed by model development and validation engine 408 to formulate a plurality of models 102, and then a determination may be made as to the best model 102 based on the goodness of the model. Example modeling methodologies may include, but are not limited to, support vector machine (SVM) models, discriminative models, K nearest neighbor (KNN) models, etc. Training feature matrix 406 may be used to train the various models 102 to emulate the operation of target system 104. For example, training may involve providing feature data from the training feature matrix to different models 102 so that they may learn how outputs of target system 104 respond to certain inputs. In at least one embodiment, model development and validation engine 408 may then validate the models. For example, model development and validation engine 408 may determine a best model 102 by judging a goodness of fit for each model 102. Goodness of fit may be determined by, for example, judging how accurately each model 103 emulates the response of target system 104 based on, for example, the data received from target system 104.

Consistent with the present disclosure, real time engine 410 may employ model 102 to perform functionality desired by a user of analytics system 100′. In one example use scenario, the user of analytics system 100′ may be an operator of target system 104, and real-time engine 410 may provide functionality that may aid the user in operating, maintaining and/or improving target system 104. For example, real time engine 410 may receive data from target system 104 (e.g., during the operation of target system 104) as shown at 422. The data received from target system 104 may be input into model 102, which may predict at least one output of target system 104 based on the input data. Real time engine 410 may react to the predictions of model 102 as specified by, for example, the user configuration of analytics system 100. For example, real time engine 410 may issue notifications in response to the output of model 102. Notifications may be provided back to UIM 106 (e.g., for presentation to the user) as shown at 424. In this regard, the notification may be audible (e.g., spoken language, alarms, etc.), visible (e.g., textual, images, videos, lighted indicators, etc.), tactile (e.g., vibration of a mobile device), etc. Consistent with the present disclosure, notifications may include predictions, alarms or diagnoses. Predictions may inform the user what the predicted output of target system 104 will be based on the inputs received at 422. Alarms may notify a user of a condition in target system 104 (e.g., an error, a failure, a process deviation, out of specification operation, quality issue, etc.) that is predicted to occur based on the inputs received at 422. Diagnoses may be provided to inform the user what can be revised, altered, fixed, etc. in target system 104 to correct a potentially dangerous, out of specification or just undesirable condition in target system 104 (e.g., signaled by a prior alarm). In at least one embodiment, real time engine may alone, or in conjunction with a notification, provide control signals to target system 104 as shown at 426. The control signals may be able to automatically alter the operation of target system 104 to, for example, avoid a predicted error or failure, bring target system 104 back into a specified operating condition, etc. While real time engine has been shown within AAM 108′ in the example of FIG. 4, consistent with the present disclosure real time engine 410 may exist elsewhere in analytics system 100′. Real time engine 410 may then interact with AAM 108′ to access or import model 102 as necessary.

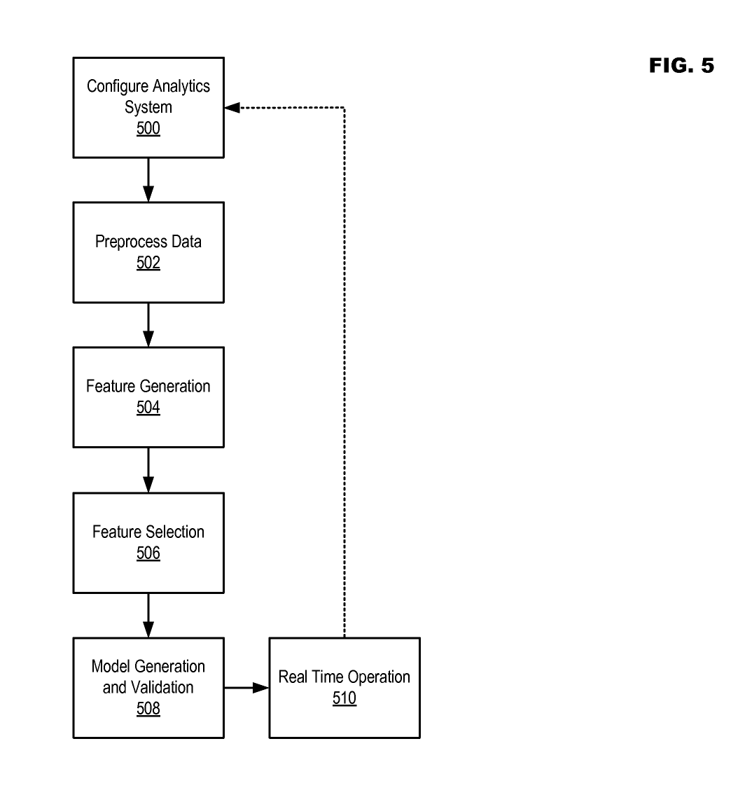

FIG. 5 illustrates example operations for analytic model development in accordance with at least one embodiment of the present disclosure. In operation 500 an analytics system may be configured. Data processing may then take place in operation 502. The processed data may then be used for feature generation in operation 504. In operation 506 a set of selected features may be selected from the features generated in operation 504. In operation 508 the selected features may be used to generate and validate a model of a target system. Real time operation may then take place in operation 510. Operation 510 may optionally be followed by a return to operation 500 when, for example, a new model is to be developed, an existing model is to be redeveloped and/or retrained, etc.

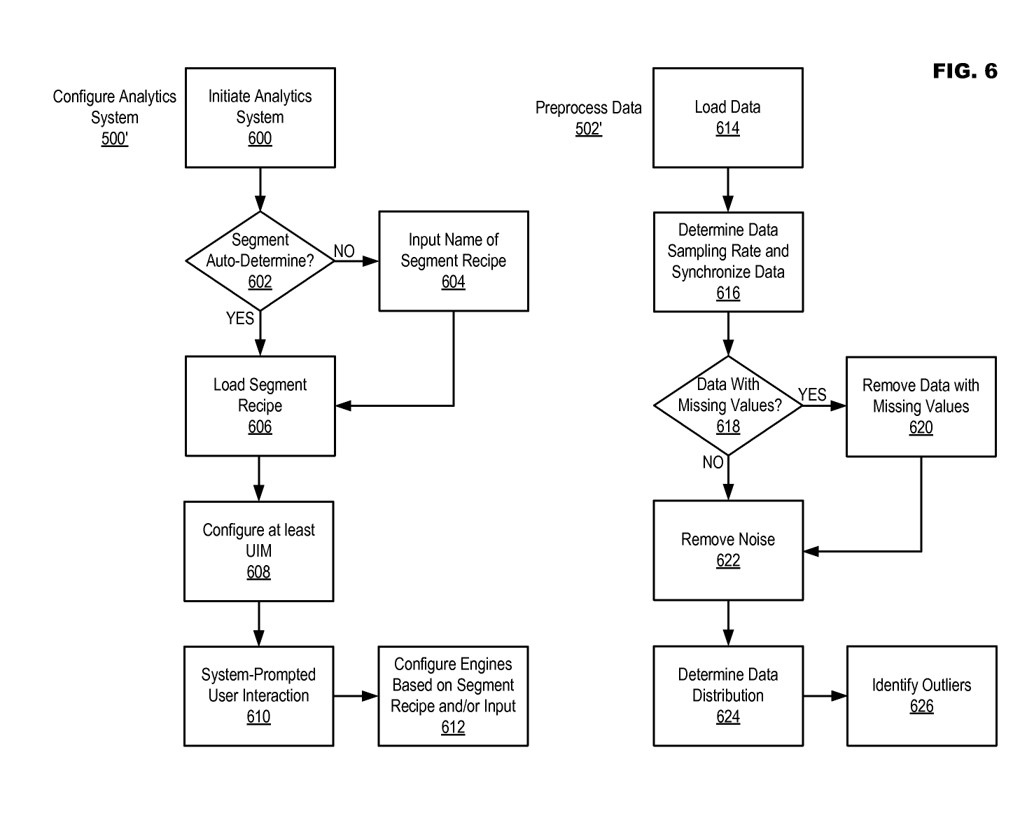

FIG. 6 illustrates example operations for analytics system configuration and data processing in accordance with at least one embodiment of the present disclosure. Operations 600 to 610 may pertain to an embodiment of operation 500′ from FIG. 5. In operation 600 the analytics system may be initiated. A determination may then be made in operation 602 as to whether the analytics system is able to auto-determine a segment recipe to load (e.g., based on data received from the target system). If in operation 602 it is determined that the analytics system is not equipped to auto-determine a segment recipe to load, then in operation 604 a user may input a segment recipe to load. Following a determination in operation 602 that the analytics system is able to auto-determine a segment recipe to load, or alternatively following operation 604, in operation 606 a segment recipe may be loaded. The segment recipe may be used to configure at least a UIM in the analytics system in operation 608, and in operation 610 system-prompted user interaction may occur. System-prompted user interaction may comprise, for example, plain language questions posed to the user to generate responsive user input (e.g., regarding a desired system configuration). In operation 612 engines in an AAM in the analytics system may be configured based on at least one of the loaded segment recipe and/or user input.

Operations 614 to 626 may pertain to an embodiment of operation 502′ from FIG. 5. In operation 614 data may be loaded from the target system. In at least one embodiment the data may be annotated data. In operation 616 data sampling rates for the data loaded in operation 614 may be determined and the data may then be synchronized based on the sampling rates (e.g., the data may be aligned so that data values sampled at the same time may correspond to each other). A determination may then be made in operation 618 as to any data having missing values, and if any data is determined to have missing values the data may be removed in operation 620. In operation 622 any noise determined to exist in the data may be removed (e.g., filtered). A data distribution may then be determined in operation 624, and in operation 626 outliers in the data may be identified.

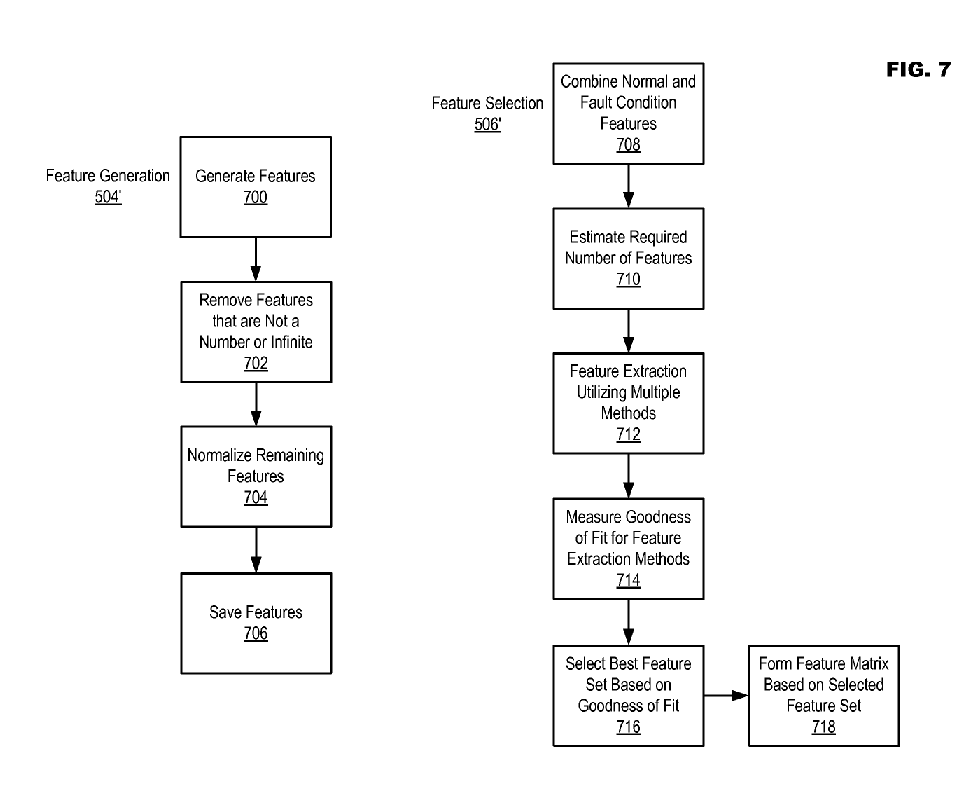

FIG. 7 illustrates example operations for feature generation and selection in accordance with at least one embodiment of the present disclosure. Operations 700 to 706 may pertain to an embodiment of operation 504′ from FIG. 5. In operation 700 features may be generated based on the data that was preprocessed in operations 614 to 626 in FIG. 6. Features may be generated by, for example, performing mathematical and/or statistical operations of the preprocessed data (e.g., in the time or frequency domain). In operation 702 any features that are determined to be not a number (NaN) or infinite may be removed. The remaining features may be normalized in operation 704, and in operation 706 the features may be saved as a group of available features.

Operations 708 to 718 may pertain to an embodiment of operation 506′ from FIG. 5. In operation 708 features corresponding to normal and fault condition may be combined, and an estimated number of features required to characterize the operation of the target system may be determined in operation 710. In operation 712 feature extraction may occur utilizing multiple methods, the goodness of each of the feature extraction methods being measured in operation 714. A best feature set may then be selected in operation 716 based on the goodness of fit that was determined in operation 714. In operation 718 a feature matrix may be formed based on the feature set selected in operation 716.

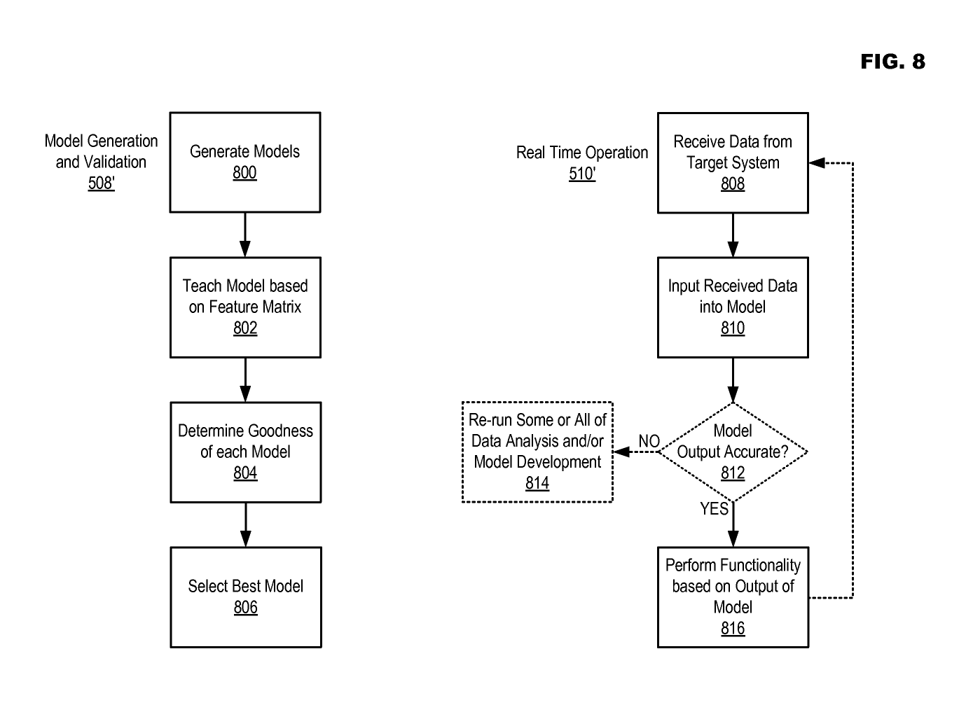

FIG. 8 illustrates example operations for model generation and validation, and real time operation in accordance with at least one embodiment of the present disclosure. Operations 800 to 806 may pertain to an embodiment of operation 508′ from FIG. 5. In operation 800 multiple models may be generated (e.g., based on different modeling methodologies). Each of the models generated in operation 800 may then be trained in operation 802 utilizing the feature matrix that was generated in operation 718 of FIG. 7. A goodness of fit of each model may be determined in operation 804, and a best model may be selected based on the goodness of fit in operation 806.

Operations 808 to 816 may pertain to an embodiment of operation 510′ from FIG. 5. In operation 808 data may be received from the target system. The received data may then be input into the model in operation 810. Operation 812 may be optional in that it is not required for all implementations of real time operation 510′. In operation 812 a determination may be made as to whether the output generated by the model is accurate (e.g., within a margin of accuracy for predicting the output of the target system that is required by at least one of the segment recipe or user configuration). For example, a segment recipe adaptation module in the analytics system may receive feedback data indicating from the target system or other sources indicating that the segment recipe may require some modification to improve and/or optimize the performance of the model and/or the analytics system. If it is determined in operation 812 that the output generated by the model is not accurate (e.g., does not predict the behavior of the target system with a required and/or desired amount of accuracy including, for example, at least a minimum accuracy level), then in operation 814 some or all of the data analysis and/or model development may be re-run (e.g., causing a return to an operation previously discussed in regard to FIGS. 5 to 8). If in operation 812 it is determined that the output of the model is accurate, then in operation 816 functionality may be performed based on the output of the model. For example, the model may generate a prediction of target system output based on the data input into the model in operation 810, and may perform functionality such as, but not limited to, generating predictions, alarms, diagnoses, etc. Operation 816 may optionally return to operation 808 to continue performing the real-time operation specified by at least one of the segment recipe or the user.

While FIGS. 5 to 8 illustrate operations according to different embodiments, it is to be understood that not all of the operations depicted in FIGS. 5 to 8 are necessary for other embodiments. Indeed, it is fully contemplated herein that in other embodiments of the present disclosure, the operations depicted in FIGS. 5 to 8, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to a system for analytic model development. In general, an analytic system may be able to formulate a model of a target system based on user interaction and data received from the system, and to perform real time activities based on the model. An analytics system may comprise at least a segment recipe module (SRM), a user interface module (UIM) and an automated analytics module (AAM). The SRM may include at least one segment recipe for use in configuring the UIM and AAM. For example, the UIM may be configured to present plain language prompts to a user. At least one of the segment recipe or data input by the user in response to the prompts may be used to configure the AAM to generate the model. The AAM may also perform real time activities that generate notifications, etc. based on the model.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for analytic model development.

According to example 1 there is provided an analytics system. The system may comprise a processing module, a user interface module to allow a user to interact with the analytics system, an automated analytics module to cause the processing module to at least generate a model of a target system and a segment recipe module to cause the processing module to configure the user interface module and the automated analytics module.

Example 2 may include the elements of example 1, wherein the segment recipe module comprises at least one segment recipe and a segment recipe selection module.

Example 3 may include the elements of example 2, wherein the segment recipe module comprises a plurality of segment recipes and the segment recipe selection module is to select a segment recipe to configure the user interface module and the automated analytics module based on user interaction with the user interface module.

Example 4 may include the elements of any of examples 2 to 3, wherein the segment recipe module comprises a plurality of segment recipes and the segment recipe selection module is to select a segment recipe to configure the user interface module and the automated analytics module based on data received from the target system.

Example 5 may include the elements of any of examples 2 to 4, wherein the segment recipe module further comprises a segment recipe adaptation module to alter at least part of the at least one segment recipe based on data received from sources internal or external to the analytics system.

Example 6 may include the elements of example 5, wherein in altering at least part of the at least one segment recipe the segment recipe adaptation module is to at least one of optimize the at least one segment recipe or improve accuracy for the model in predicting target system behavior.

Example 7 may include the elements of any of examples 5 to 6, wherein the sources external to the analytics system comprise at least the target system.

Example 8 may include the elements of any of examples 5 to 7, wherein the data received from sources internal or external to the analysis system comprises at least domain-specific crowd-sourced response analytics.

Example 9 may include the elements of any of examples 2 to 8, wherein the at least one segment recipe comprises a user interaction/terminology configuration to at least cause the user interface module to present prompts configured to guide the user in inputting data for use in configuring the automated analytics module.

Example 10 may include the elements of example 9, wherein the prompts are formulated using plain language.

Example 11 may include the elements of any of examples 9 to 10, wherein the at least one segment recipe further comprises at least a general configuration, a data configuration and a model configuration.

Example 12 may include the elements of any of examples 1 to 11, wherein the automated analytics module comprises at least a data preprocessing engine, a feature generation engine, a feature selection engine and a model development and validation engine.

Example 13 may include the elements of example 12, wherein the model development and validation engine is to generate a plurality of models based at least on data received from the target system and to determine a best model from the plurality of models based on measuring a goodness of fit for teach of the plurality of models.

Example 14 may include the elements of example 13, wherein the plurality of models comprise at least a support vector machine model, a discriminative model and a K nearest neighbor model.

Example 15 may include the elements of any of examples 13 to 14, wherein the feature selection engine is to generate a training feature matrix for training the plurality of models. Example 16 may include the elements of any of examples 1 to 15, where the automated analytics module further comprises a real time engine to input data received from the target system into the model and cause at least one of a notification to be presented by the user interface module, or a control signal to be transmitted to the target system, based on an output generated by the model.

Example 17 may include the elements of example 16, wherein in providing a notification the real time engine is to cause the user interface module to present at least one of a prediction, a diagnosis or an alarm.

Example 18 may include the elements of any of examples 1 to 17, wherein the segment recipe module comprises a plurality of segment recipes and a segment recipe selection module to select a segment recipe to configure the user interface module and the automated analytics module based on at least one of user interaction with the user interface module or data received from the target system.

Example 19 may include the elements of any of examples 1 to 18, wherein the segment recipe module comprises a segment recipe adaptation module to alter at least part of at least one segment recipe in the segment recipe module based on data received from sources internal or external to the analytics system.

Example 20 may include the elements of any of examples 1 to 19, wherein the segment recipe module comprises at least one segment recipe including a user interaction/terminology configuration to at least cause the user interface module to present prompts formulated using plain language and configured to guide the user in inputting data for use in configuring the automated analytics module.

According to example 21 there is provided a method for model development. The method may comprise configuring an analytics system based at least on a segment recipe, preprocessing, in the analytics system, data received from a target system, generating, in the analytics system, features based on the preprocessed data, selecting, in the analytics system, a set of features from the generated features and generating, in the analytics system, a model based on the selected set of features.

Example 22 may include the elements of example 21, wherein configuring the analysis system comprises selecting a segment recipe from a plurality of segment recipes and loading the selected segment recipe into the analytics system.

Example 23 may include the elements of example 22, and may further comprise configuring a user interface module in the analytics system based on the selected segment recipe, presenting prompts via the user interface module, receiving user input via the user interface module and configuring an automated analytics module in the analytics system based on the segment recipe and the user input.

Example 24 may include the elements of any of examples 21 to 23, wherein generating, in the analytics system, the model based on the selected set of features comprises generating models based on different modeling methodologies and selecting a best model by measuring a goodness of fit for each of the models.

Example 25 may include the elements of example 24, wherein the models comprise at least a support vector machine model, a discriminative model and a K nearest neighbor model.

Example 26 may include the elements of any of examples 21 to 25, and may further comprise altering at least part of the segment recipe based on data received from sources internal or external to the analytics system.

Example 27 may include the elements of example 26, wherein altering at least part of the at least one segment recipe comprises at least one of optimizing the at least one segment recipe or improving accuracy for the model in predicting target system behavior.

Example 28 may include the elements of any of examples 26 to 27, wherein the sources external to the analytics system comprise at least the target system.

Example 29 may include the elements of any of examples 26 to 28, wherein the data received from sources internal or external to the analysis system comprises at least domain-specific crowd-sourced response analytics.

Example 30 may include the elements of any of examples 21 to 29, and may further comprise inputting, in the analytics system, data from the target system into the model and providing, in the analytics system, at least a notification based on an output generated by the model.

Example 31 may include the elements of any of examples 21 to 30, wherein configuring the analysis system comprises selecting a segment recipe from a plurality of segment recipes, loading the selected segment recipe into the analytics system, configuring a user interface module in the analytics system based on the selected segment recipe, presenting prompts via the user interface module, receiving user input via the user interface module and configuring an automated analytics module in the analytics system based on the segment recipe and the user input.

According to example 32 there is provided a system including at least a device, the system being arranged to perform the method of any of the above examples 21 to 31.

According to example 33 there is provided a chipset arranged to perform the method of any of the above examples 21 to 31.

According to example 34 there is provided at least one machine readable medium comprising a plurality of instructions that, in response to be being executed on a computing device, cause the computing device to carry out the method according to any of the above examples 21 to 31.

According to example 35 there is provided at least one device to formulate a model of a target system, the at least one device being arranged to perform the method of any of the above examples 21 to 31.

According to example 36 there is provided a system for model development. The system may comprise means for configuring an analytics system based at least on a segment recipe, means for preprocessing, in the analytics system, data received from a target system, means for generating, in the analytics system, features based on the preprocessed data, means for selecting, in the analytics system, a set of features from the generated features and means for generating, in the analytics system, a model based on the selected set of features.

Example 37 may include the elements of example 36, wherein the means for configuring the analysis system comprise means for selecting a segment recipe from a plurality of segment recipes and means for loading the selected segment recipe into the analytics system.

Example 38 may include the elements of example 37, and may further comprise means for configuring a user interface module in the analytics system based on the selected segment recipe, means for presenting prompts via the user interface module, means for receiving user input via the user interface module and means for configuring an automated analytics module in the analytics system based on the segment recipe and the user input.

Example 39 may include the elements of any of examples 36 to 38, wherein the means for generating, in the analytics system, the model based on the selected set of features comprise means for generating models based on different modeling methodologies and means for selecting a best model by measuring a goodness of fit for each of the models.

Example 40 may include the elements of example 39, wherein the models comprise at least a support vector machine model, a discriminative model and a K nearest neighbor model.

Example 41 may include the elements of any of examples 36 to 40, and may further comprise means for altering at least part of the segment recipe based on data received from sources internal or external to the analytics system.

Example 42 may include the elements of example 41, wherein the means for altering at least part of the at least one segment recipe comprise means for at least one of optimizing the at least one segment recipe or improving accuracy for the model in predicting target system behavior.

Example 43 may include the elements of any of examples 41 to 42, wherein the sources external to the analytics system comprise at least the target system.

Example 44 may include the elements of any of examples 41 to 43, wherein the data received from sources internal or external to the analysis system comprises at least domain-specific crowd-sourced response analytics.

Example 45 may include the elements of any of examples 36 to 44, and may further comprise means for inputting, in the analytics system, data from the target system into the model and means for providing, in the analytics system, at least a notification based on an output generated by the model.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. An analytics system, comprising:
a processing module;
a user interface module to allow a user to interact with the analytics system;
an automated analytics module to cause the processing module to at least generate a model of a target system; and
a segment recipe module to cause the processing module to configure the user interface module and the automated analytics module.

2. The system of claim 1, wherein the segment recipe module comprises at least one segment recipe and a segment recipe selection module.

3. The system of claim 2, wherein the segment recipe module comprises a plurality of segment recipes and the segment recipe selection module is to select a segment recipe to configure the user interface module and the automated analytics module based on user interaction with the user interface module.

4. The system of claim 2, wherein the segment recipe module comprises a plurality of segment recipes and the segment recipe selection module is to select a segment recipe to configure the user interface module and the automated analytics module based on data received from the target system.

5. The system of claim 2, wherein the segment recipe module further comprises a segment recipe adaptation module to alter at least part of the at least one segment recipe based on data received from sources internal or external to the analytics system.

6. The system of claim 2, wherein the at least one segment recipe comprises a user interaction/terminology configuration to at least cause the user interface module to present prompts configured to guide the user in inputting data for use in configuring the automated analytics module.

7. The system of claim 6, wherein the prompts are formulated using plain language.

8. The system of claim 6, wherein the at least one segment recipe further comprises at least a general configuration, a data configuration and a model configuration.

9. The system of claim 1, wherein the automated analytics module comprises at least a data preprocessing engine, a feature generation engine, a feature selection engine and a model development and validation engine.

10. The system of claim 9, wherein the model development and validation engine is to generate a plurality of models based at least on data received from the target system and to determine a best model from the plurality of models based on measuring a goodness of fit for teach of the plurality of models.

11. The system of claim 10, wherein the feature selection engine is to generate a training feature matrix for training the plurality of models.

12. The system of claim 1, where the automated analytics module further comprises a real time engine to input data received from the target system into the model and cause at least one of a notification to be presented by the user interface module, or a control signal to be transmitted to the target system, based on an output generated by the model.

13. The system of claim 12, wherein in providing a notification the real time engine is to cause the user interface module to present at least one of a prediction, a diagnosis or an alarm.

14. A method for model development, comprising:
configuring an analytics system based at least on a segment recipe;
preprocessing, in the analytics system, data received from a target system;
generating, in the analytics system, features based on the preprocessed data;
selecting, in the analytics system, a set of features from the generated features; and
generating, in the analytics system, a model based on the selected set of features.

15. The method of claim 14, wherein configuring the analysis system comprises:
selecting a segment recipe from a plurality of segment recipes; and
loading the selected segment recipe into the analytics system.

16. The method of claim 15, further comprising:
configuring a user interface module in the analytics system based on the selected segment recipe;
presenting prompts via the user interface module;
receiving user input via the user interface module; and
configuring an automated analytics module in the analytics system based on the segment recipe and the user input.

17. The method of claim 14, wherein generating, in the analytics system, the model based on the selected set of features comprises:
generating models based on different modeling methodologies; and
selecting a best model by measuring a goodness of fit for each of the models.

18. The method of claim 14, further comprising:
altering at least part of the segment recipe based on data received from sources internal or external to the analytics system.

19. The method of claim 14, further comprising:
inputting, in the analytics system, data from the target system into the model; and
providing, in the analytics system, at least a notification based on an output generated by the model.

20. At least one machine-readable storage medium having stored thereon, individually or in combination, instructions for model development that, when executed by one or more processors, cause the one or more processors to:
configure an analytics system based at least on a segment recipe;
preprocess, in the analytics system, data received from a target system;
generate, in the analytics system, features based on the preprocessed data;
select, in the analytics system, a set of features from the generated features; and
generate, in the analytics system, a model based on the selected set of features.

21. The medium of claim 20, wherein the instructions to configure the analysis system comprise instructions to:
select a segment recipe from a plurality of segment recipes; and
load the selected segment recipe into the analytics system.

22. The medium of claim 21, further comprising instructions that, when executed by one or more processors, cause the one or more processors to:
configure a user interface module in the analytics system based on the selected segment recipe;
present prompts via the user interface module;
receive user input via the user interface module; and
configure an automated analytics module in the analytics system based on the segment recipe and the user input.

23. The medium of claim 20, wherein the instructions to generate, in the analytics system, the model based on the selected set of features comprise instructions to:
generate models based on different modeling methodologies; and
select a best model by measuring a goodness of fit for each of the models.

24. The medium of claim 20, further comprising instructions that, when executed by one or more processors, cause the one or more processors to:
alter at least part of the segment recipe based on data received from sources internal or external to the analytics system.

25. The medium of claim 20, further comprising instructions that, when executed by one or more processors, cause the one or more processors to:
input, in the analytics system, data from the target system into the model; and
provide, in the analytics system, at least a notification based on an output generated by the model.
